(19) United States
(12) Patent Application Publication
(10) Pub. No.: US 2018/0101880 A1
(43) Pub. Date: Apr. 12, 2018

(54) SYSTEM FOR MANAGING MOBILE CLEANING SERVICES

(71) Applicant: Christinan C. Colantoni, San Francisco, CA (US)

(72) Inventor: Christinan C. Colantoni, San Francisco, CA (US)

(21) Appl. No.: 15/286,945

(22) Filed: Oct. 6, 2016

(51) Int. Cl. G06Q 30/06; G06Q 10/06

(52) U.S. Cl. CPC G06Q 30/0601; G06Q 10/06311

(57) ABSTRACT

A system for ordering cleaning services remotely, using an application downloaded into a smartphone or the like. A commercial provider of cleaning services maintains a fleet of vehicles provided with cleaning apparatus. A prospective customer can plan and order cleaning services from a menu using the application. Cleaning services may be on an “as available” basis, or alternatively, may be scheduled for a particular time of day. The customer specifies a location for the cleaning service, and places an order for the cleaning service via the application. If the service is desired as soon as a cleaning vehicle becomes available, this may be annunciated to the customer via the application. After the cleaning service is rendered, the customer can pay for the service, including an option for tipping, and report an assessment of effectiveness of the cleaning personnel, using the application and smartphone.

### FIELD OF THE DISCLOSURE

The present disclosure relates to a system for arranging and managing commercially offered cleaning care services using remote wireless communications.

### BACKGROUND

People frequently want to maintain their transportation vehicles in a clean and attractive condition. This may be a matter of personal standards, or may reflect professional obligations and expectations, such as for example might be desired by a real estate salesperson who is driving prospective customers to various potential real estate offerings. Ordinarily, a vehicle owner can drive to the nearest vehicle washing or detailing facility and obtain the desired service. But in a number of communities, high traffic density, far flung geographic locations of suitable service sites, time constraints imposed on the schedule of the person desiring vehicle cleaning services, and other factors render it unfeasible to drive to a location of a service site.

There exists a need to expedite services for washing and detailing motor vehicles in an urban and/or suburban setting.

### SUMMARY

The disclosed concepts address the above stated situation by providing a system for ordering cleaning services remotely, using an application downloaded into a smartphone or the like. A commercial provider of cleaning services maintains a fleet of vehicles provided with cleaning apparatus. A prospective customer can plan and order cleaning services from a menu using the application. Cleaning services may be on an “as available” basis, or alternatively, may be scheduled for a particular time of day. The customer specifies a location for the cleaning service, and places an order for the cleaning service via the application. If the service is desired as soon as a cleaning vehicle becomes available, this is annunciated to the customer via the application. After the cleaning service is rendered, using the application, the customer can pay for the service, including an option for tipping, and report an assessment of effectiveness of the cleaning personnel.

### BRIEF DESCRIPTION OF THE DRAWINGS

Various objects, features, and attendant advantages of the disclosed concepts will become more fully appreciated as the same becomes better understood when considered in conjunction with the accompanying drawings, in which like reference characters designate the same or similar parts throughout the several views, and wherein:

FIG. 1 is a diagrammatic view of the environment of the novel method, showing apparatus used in conjunction therewith, according to at least one aspect of the disclosure;

FIG. 2 is a diagrammatic plan view of screen content of a smartphone used to implement the novel method via an application downloaded to the smartphone;

FIGS. 3-7 are each a diagrammatic plan view showing other screen content displayed on the smartphone seen in FIG. 2, the other screen content obtained from the application; and

FIG. 8 is a perspective view of an optional lockbox usable with the method.

### DETAILED DESCRIPTION

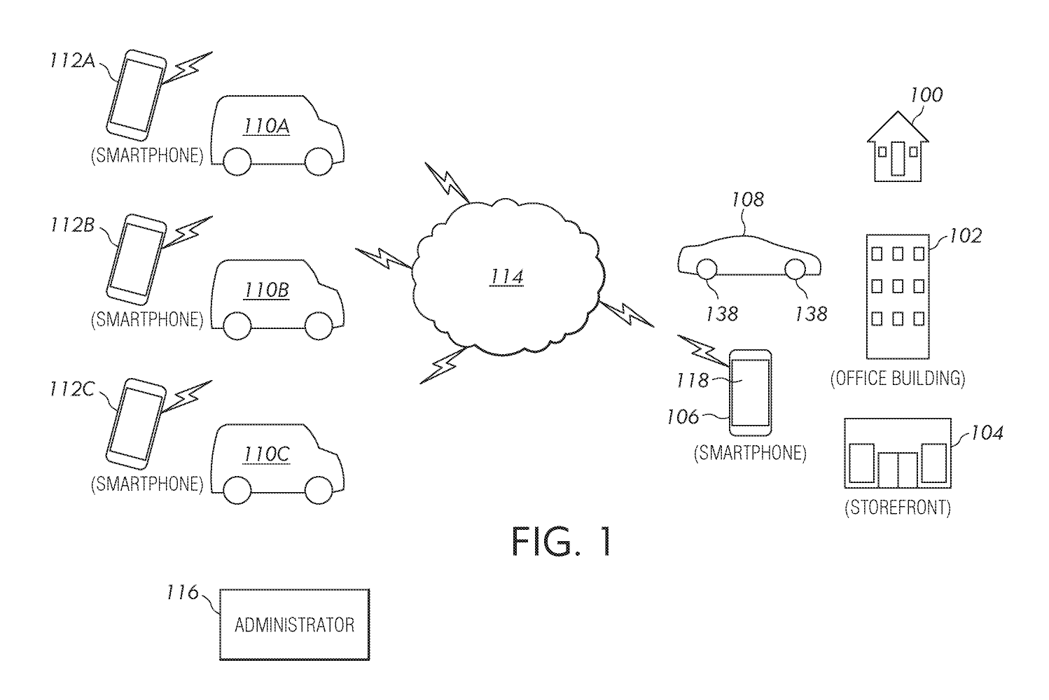

Referring first to FIG. 1, according to at least one aspect of the invention, there is shown apparatus of a method for remotely summoning and obtaining cleaning services by a customer, and delivering mobile cleaning services to premises of the customer. The customer (not explicitly shown) is a member of the general public for whom the cleaning services are commercially available. Because of the mobile nature of the novel cleaning services, the customer may be located at his or her residence 100, at a place of employment, shown representatively as an office building 102, may be shopping at a store 104, or may be at any other location including traveling on a highway, visiting a park, a beach, a resort, a hotel, (the latter options are not shown) or otherwise located. The customer has a wireless communications device such as a smartphone 106. In the illustrated example of the novel method, the customer owns or uses a motor vehicle 108, which motor vehicle 108 is to be the object of the cleaning services.

A service supplier of the cleaning services maintains a fleet of mobile cleaning vehicles 110A, 110B, 110C. The driver or operator of each of mobile cleaning vehicles 110A, 110B, 110C has a mobile communications device such as a smartphone 112A, 112B, or 112C, thereby enabling wireless communications via a suitable communications network 114. Communications network 114 and wireless communications relied on herein may imply use of the internet, cellular telephone networks (not shown), other wireless communications channels (not shown), or any combination of these.

The service supplier operating mobile cleaning vehicles 110A, 110B, 110C is represented herein as an administrator 116 having fixed or mobile premises or both. Administrator 116 performs administrative functions, such as processing incoming service requests and dispatching mobile cleaning vehicles 110A, 110B, 110C, among others. Functions of administrator 116 may be performed manually, automatically, or by a combination of these. Administrator 116 maintains communications capability for communicating with mobile cleaning vehicles 110A, 110B, 110C and with customers.

In an implementation of the method, smartphone 106 has a display screen 118. It would be possible to implement the method in the absence of display screen 118, such as by using the customer's personal computer, tablet, or other display device (none of these is shown). Also, data entry to implement the method may utilize inputs based on depressing keys or in ways other than touching display screen 118.

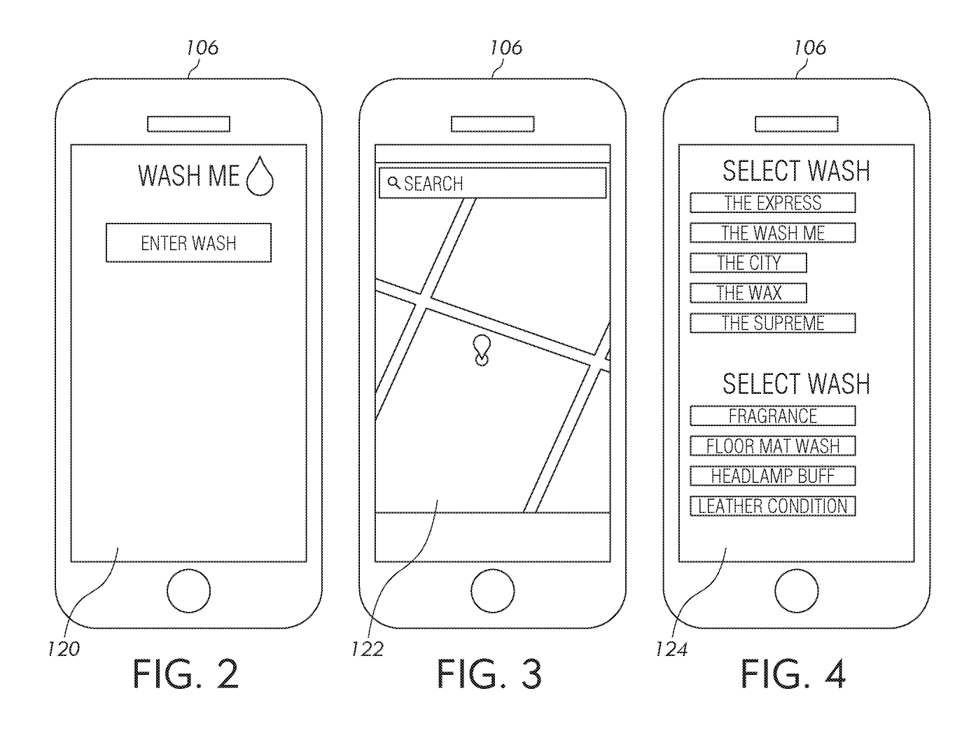

Referring also to FIG. 2, an exemplary opening screen 120 may identify the computer application by for example a service mark, logo, text, or in other ways, and may display a prompt to enter an input furthering implementation of the novel method. As employed herein, “display screen 118” will refer to the apparatus of smartphone 106 under discussion, whereas all other mentions of “screen” will refer to displayed content, and not to the physical display screen 118 itself.

Using the above described apparatus, a novel method for remotely summoning and obtaining cleaning services by a customer, and delivering mobile cleaning services to premises 100, 102, or 104 of the customer may comprise making commercially available at least one mobile cleaning vehicle 110A, 110B, or 110C containing cleaning service apparatus; receiving a request for customer specified cleaning services from a wireless communications device (e.g., smartphone 106) for the mobile cleaning services to be implemented at a customer specified time and customer specified premises 100, 102, or 104; dispatching mobile cleaning vehicle 110A, 110B, or 110C to the specified premises 100, 102, or 104 at the specified time; and performing the customer specified cleaning services at the specified premises 100, 102, or 104 at the customer specified time.

Cleaning service apparatus contained in each mobile cleaning vehicle 110A, 110B, or 110C may include an onboard water tank, electric water pressurization pump, electric vacuum, washer and dryer for towels and chamois wipes, a diesel generator, and an inflatable vehicle water gathering bladder with a filter for separating contaminants from spent wash water (none of these is shown), as non-exhaustive examples.

Mobile cleaning vehicles 110A, 110B, 110C and cleaning service apparatus such as those listed above may reflect environmentally conscious practice. Fore example, mobile cleaning vehicles 110A, 110B, 110C may be electric or hybrid vehicles. The diesel generator may use biofuel such as vegetable oil. The inflatable vehicle water gathering bladder with a filter may be arranged for at least partial reuse of treated spent wash water. Cleaning materials may include biodegradable soaps and waxes.

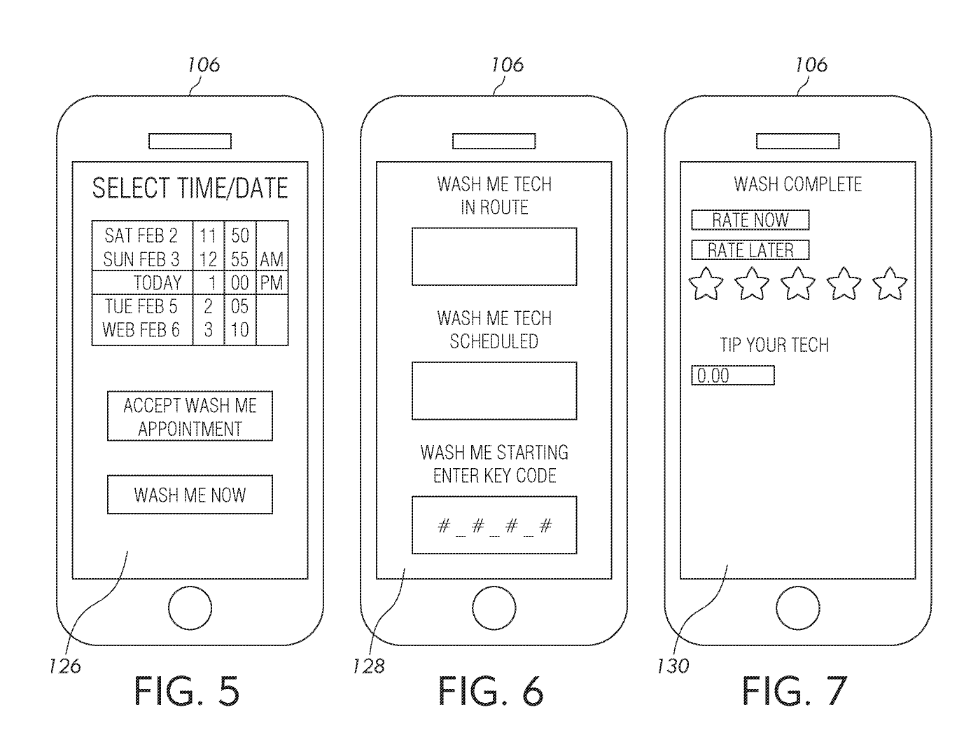

Receiving the request for customer specified cleaning services from the wireless communications device (e.g., smartphone 106) may utilize an application downloaded to the wireless communications device. This application may launch opening screen 120 (FIG. 2), and additional screens 122 (FIG. 3), 124 (FIG. 4), 126 (FIG. 5), 128 (FIG. 6), and 130 (FIG. 7). Each screen 122, 124, 126, 128, 130 presents the customer with options and steps to be performed in specifying, ordering, and paying for desired services, service time and date, and service location. The service location need not be limited to the customer's residence or to the customer's present location.

Therefore, the method may comprise downloading into customer wireless communications device (e.g., smartphone 106) a computer executable or implementable program or application which is functional to implement data processing steps for presenting a menu of specific cleaning services, as illustrated in FIG. 4; accepting customer inputs making selections from the menu of specific cleaning services; accepting customer inputs identifying the specified premises and the customer specified time, as illustrated in FIG. 5, and transmitting the request for customer specified cleaning services to administrator 116 having authority and capability of dispatching the mobile cleaning device 110A, 110B, or 110C to implement the customer specified cleaning services.

Prior to implementing the cleaning services, the enterprise performing the cleaning services may as a courtesy for example advise the customer that a mobile cleaning device 110A, 110B, or 110C is enroute12. The method may then comprise confirming to the customer by remote communications when one of the plurality of mobile cleaning vehicles 110A, 110B, 110C is enroute to perform the cleaning services. This remote communication may be caused to appear on a screen 128 (FIG. 6) of smartphone 106.

The method may further comprise receiving the request for customer specified cleaning services by administrator 116; and implementing the steps of performing the customer specified cleaning services at the specified premises 100, 102, or 104 at the customer specified time and dispatching mobile cleaning vehicle 110A, 110B, or 110C to the specified premises 100, 102, or 104 at the specified time responsive to receiving the request by administrator 116. Once the customer has made all selections necessary to order cleaning services, the application may display a prompt to actually transmit the service request to administrator 116 (this step is not shown as a screen). The prompt may for example display a virtual button to be touched to implement the service request.

In the method the step of making commercially available at least one mobile cleaning vehicle 110A, 110B, or 110C containing cleaning service apparatus comprises making commercially available a plurality of mobile cleaning vehicles 110A, 110B, 110C each containing cleaning service apparatus. The method may further comprise identifying a most feasible one of the plurality of mobile cleaning vehicles 110A, 110B, 110C as that mobile cleaning vehicle 110A, 110B, or 110C to be dispatched to the specified premises 100, 102, or 104 at the specified time. The most feasible one of the plurality of mobile cleaning vehicles 110A, 110B, 110C will in most instances be that which is available at a time the closest to the service time and date requested by the customer.

The method may further comprise downloading into the customer wireless communications device a computer executable or implementable program or application which is functional to implement data processing steps for identifying to the customer a soonest anticipated time to provide the requested cleaning service. This time may appear on a screen of smartphone 106.

The method may further comprise downloading into the customer wireless communications device (e.g., smartphone 106) a computer executable or implementable program or application which is functional to implement data processing steps for selecting a priorly utilized service location as the specified premises 100, 102, or 104. For example, it may be most convenient to the customer to have cleaning services performed while the customer is at work. If cleaning services are ordered on a continuing basis, the customer is thus afforded the option of selected the priorly utilized service location, which will have been entered into memory by administrator 116.

The method may further further comprise downloading into the customer wireless communications device a computer executable or implementable program or application which is functional to implement data processing steps for authorizing remote payment for the cleaning service through the wireless communications device. The application may make provision for debiting of a debit, checking, or savings account, or applying a charge against a charge account, for example. The method may further comprise downloading into the customer wireless communications device a computer executable or implementable program or application which is functional to implement data processing steps for adding a tip to payment for the cleaning services.

The method may further comprise downloading into the customer wireless communications device a computer executable or implementable program or application which is functional to implement data processing steps for receiving an input indicative of the customer's opinion of quality of service received from service personnel performing the requested cleaning services; and transmitting the input indicative of the customer's opinion of quality of service to administrator 116. This is illustrated as screen 130 in FIG. 7.

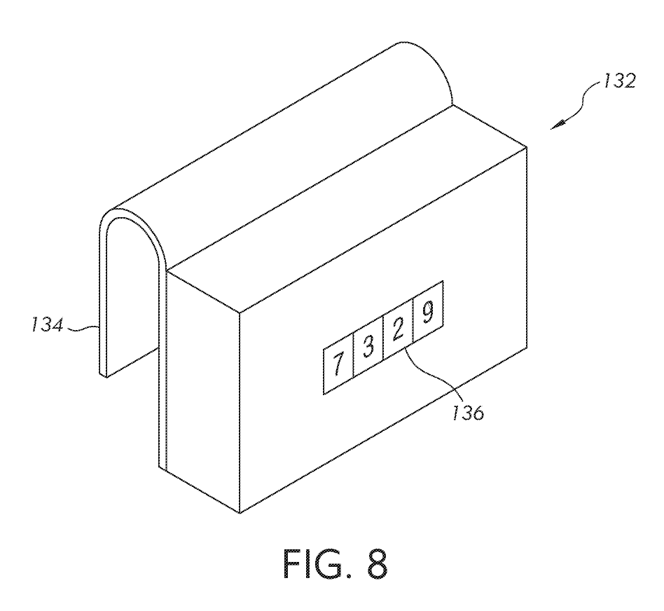

It may be desirable for service personnel performing the requested cleaning services to have access to the interior of motor vehicle 108 without obliging the customer to be present. To this end, and referring to FIG. 8, the method may further comprise providing a lock box 132 for storing a key (not shown) to motor vehicle 108, lock box 132 to be mounted on motor vehicle 108, so that service personnel performing the requested cleaning services may enter motor vehicle 108 without the vehicle owner being present, and the owner can retrieve the key to operate motor vehicle 108 after the service personnel have left. Lock box 108 may include a clip 134 which may be entrapped on a window (not separately shown) of motor vehicle 108. Lock box 108 may have a rotary combination arrangement 136 enabling an authorized person having the combination to open lock box 108 and to access the key to motor vehicle 108. The lock box 108 may have in addition to the traditional combination, or in the alternative, a cellular activated unlocking mechanism. It is further contemplated that the lock box 108 may have a key fob that includes Rf blocking padding on the interior to prevent an unintended individual from gaining access to the lock box.

For cleaning motor vehicle 108, the method may further comprise having the customer select at least one of the cleaning services including washing the exterior (not shown) of motor vehicle 108; cleaning and vacuuming the interior (not shown) of motor vehicle 108; dressing tires 138 of motor vehicle 108; applying a fragrance to motor vehicle 108; applying wax to motor vehicle 108; detailing the interior of motor vehicle 108; treating floor mats (not shown) with shampoo; buffing the vehicle headlights (not shown); and conditioning leather upholstery (not shown) of motor vehicle 108.

Motor vehicle 108 may be provided with a GPS locator, so that its location may be determined and transmitted to either the cleaning service personnel, to assist in identifying motor vehicle 108, or to the customer, to assist in finding motor vehicle 108 if moved by the cleaning service personnel, or if left in a large parking lot, for example, such that the customer may not remember where motor vehicle 108 had been parked. The application for implementing cleaning services may be adapted to include a feature for locating motor vehicle 108 for the benefit of cleaning service personnel and the customer.

While the novel method has been described in terms of a vehicle washing enterprise, it will be appreciated that other things, such as boats, piers, loading docks, buildings, machinery, conveyors, signage and other items and facilities could be cleaned using the novel method.

While the disclosed concepts have been described in connection with what is considered the most practical and preferred implementation, it is to be understood that the disclosed concepts are not to be limited to the disclosed arrangements, but are intended to cover various arrangements which are included within the spirit and scope of the broadest possible interpretation of the appended claims so as to encompass all modifications and equivalent arrangements which are possible.

I claim:

1. A method for remotely summoning and obtaining cleaning services by a customer, and delivering mobile cleaning services to premises of the customer, the method comprising:
making commercially available at least one mobile cleaning vehicle containing cleaning service apparatus;
receiving a request for customer specified cleaning services from a wireless communications device for the mobile cleaning services to be implemented at a customer specified time and customer specified premises;
dispatching the mobile cleaning vehicle to the specified premises at the specified time; and
performing the customer specified cleaning services at the specified premises at the customer specified time.

2. The method of claim 1, further comprising:
downloading into a customer wireless communications device a computer executable or implementable program or application which is functional to implement data processing steps for
presenting a menu of specific cleaning services;
accepting customer inputs making selections from the menu of specific cleaning services;
accepting customer inputs identifying the specified premises and the customer specified time, and
transmitting the request for customer specified cleaning services to an administrator having authority and capability of dispatching the mobile cleaning device to implement the customer specified cleaning services.

3. The method of claim 2, further comprising:
receiving the request for customer specified cleaning services by the administrator; and
implementing the steps of performing the customer specified cleaning services at the specified premises at the customer specified time and dispatching the mobile cleaning vehicle to the specified premises at the specified time responsive to receiving the request by the administrator.

4. The method of claim 1, wherein
the step of making commercially available at least one mobile cleaning vehicle containing cleaning service apparatus comprises making commercially available a plurality of mobile cleaning vehicles each containing cleaning service apparatus, and
the method further comprises identifying a most feasible one of the plurality of mobile cleaning vehicles as that mobile cleaning vehicle to be dispatched to the specified premises at the specified time.

5. The method of claim 1, further comprising downloading into the customer wireless communications device a computer executable or implementable program or application which is functional to implement data processing steps for identifying to the customer a soonest anticipated time to provide the requested cleaning service.

6. The method of claim 1, further comprising downloading into the customer wireless communications device a computer executable or implementable program or application which is functional to implement data processing steps for selecting a priorly utilized service location as the specified premises.

7. The method of claim 1, further comprising downloading into the customer wireless communications device a computer executable or implementable program or application which is functional to implement data processing steps for authorizing remote payment for the cleaning service through the wireless communications device.

8. The method of claim 7, further comprising downloading into the customer wireless communications device a computer executable or implementable program or application which is functional to implement data processing steps for adding a tip to payment for the cleaning services.

9. The method of claim 1, further comprising downloading into the customer wireless communications device a computer executable or implementable program or application which is functional to implement data processing steps for
receiving an input indicative of the customer's opinion of quality of service received from service personnel performing the requested cleaning services; and
transmitting the input indicative of the customer's opinion of quality of service to the administrator.

10. The method of claim 1, further comprising providing a lock box for storing a key to the vehicle, the lock box to be mounted on the vehicle, so that service personnel performing the requested cleaning services may enter the vehicle without the vehicle owner being present, and the owner can retrieve the key to operate the vehicle after the service personnel have left.

11. The method of claim 1, further comprising having the customer select at least one of the cleaning services including washing the exterior of the vehicle; cleaning and vacuuming the interior of the vehicle; dressing tires of the vehicle; applying a fragrance to the vehicle; applying wax to the vehicle; detailing the interior of the vehicle; treating floor mats with shampoo; buffing the vehicle headlights; and conditioning leather upholstery.

12. The method of claim 1, further comprising confirming to the customer by remote communications when one of the plurality of mobile cleaning vehicles is enroute to perform the cleaning services.
